(19) United States
(12) Patent Application Publication
(10) Pub. No.: US 2024/0359347 A1
(43) Pub. Date: Oct. 31, 2024

(54) Corrosion Protector for Razor Blades

(71) Applicant: Michael Beers, Canyon Lake, TX (US)

(72) Inventor: Michael Beers, Canyon Lake, TX (US)

(21) Appl. No.: 18/308,458

(22) Filed: Apr. 27, 2023

(51) Int. Cl. B26B 21/40; B26B 21/14; C25F 7/00

(52) U.S. Cl. CPC B26B 21/4068; B26B 21/14; C25F 7/00

(57) ABSTRACT

An apparatus has a first pressure head on a first body, a second pressure head on a second body, a mechanism between the first and the second bodies, adapting the first and the second pressure heads to close together and to open, a substantially planar sacrificial anode joined to the first pressure head on a surface facing the second pressure head, a force mechanism between the first and the second bodies providing force urging the pressure heads together, and a manually operable mechanism adapted to counteract the force mechanism to separate the pressure heads.

### BACKGROUND OF THE INVENTION

### 1. Field of the Invention

The present invention is in the technical field of apparatus for corrosion protection and pertains more particularly to a device providing galvanic protection for razor blades mounted in a safety razor.

### 2. Description of Related Art

The process of corrosion protection by use of a galvanic anode is well known in the art, and such anodes are mounted on the hulls of ships, for example, to preferentially corrode rather than the steel of the hull corroding. The process is known as passive galvanic cathodic protection. There are also in the art safety razors that have included in the construction of the razor material elements that behave as sacrificial anodes to corrode preferentially to the Blade itself corroding. One such safety razor is taught in US Patent Application Publication 2019/0358837. To the inventor's knowledge, however, there is no device in the art separate from the safety razor that is adapted to pair a galvanic sacrificial anode with a razor blade while that blade is still captured in the safety razor, between uses. Such a device is needed in the art to provide passive galvanic cathode protection for blades that may be mounted in a broad variety of safety razors that are not equipped with sacrificial anode material.

### BRIEF SUMMARY OF THE INVENTION

In an embodiment of the invention an apparatus is provided comprising a first pressure head on a first body, a second pressure head on a second body, a mechanism between the first and the second bodies, adapting the first and the second pressure heads to close together and to open, a substantially planar sacrificial anode joined to the first pressure head on a surface facing the second pressure head, a force mechanism between the first and the second bodies providing force urging the pressure heads together, and a manually operable mechanism adapted to counteract the force mechanism to separate the pressure heads.

In one embodiment the first and the second body are elongated bodies joined by a pivot mechanism at a substantially central point such that urging the elongated bodies toward one another on an end of the apparatus opposite the pressure heads opens the pressure heads, and releasing the elongated bodies on the same end closes the pressure heads. Also in one embodiment the force mechanism is a spring engaging the elongated bodies urging the pressure heads together. In one embodiment the pressure heads and the substantially planar sacrificial anode are substantially circular. And in one embodiment the first and second elongated bodies are symmetrical about a long axis and the pressure heads and the sacrificial anode are adapted to approximate the shape of a head of a safety razor, each having a greater dimension at a right angle to the long axis and a smaller dimension in the direction of the long axis. In one embodiment the substantially planar sacrificial anode is made predominantly of zinc, and in one embodiment the substantially planar sacrificial anode is made predominantly of magnesium.

In another aspect of the invention a method is provided, comprising joining a sacrificial anode to a first pressure head on an end of a first body on a surface of the first body facing a second pressure head on an end of a second body, adapting a first mechanism between the first and the second bodies enabling the bodies to separate and to close together, separating and closing the first and the second pressure heads, adapting a second mechanism between the first and the second bodies providing force urging the pressure heads together, providing a manually operable mechanism adapted to counteract the force mechanism to separate the pressure heads, manipulating the manually operable mechanism, separating the pressure heads, positioning the second pressure head above a shaving head of a safety razor with the first pressure head having the sacrificial anode below the shaving head, on a side of the shaving head having blades, and manipulating the manually operable mechanism allowing the pressure heads to close, the sacrificial anode urged against the blades in the shaving head of the safety razor.

In one embodiment the method further comprises leaving the pressure heads clamped to the shaving head, protecting the razor blades from corrosion, until the razor is again required for use. In one embodiment the manually operated mechanism comprises the first and the second body as elongated bodies joined by a pivot mechanism at a substantially central point, manipulating the mechanism comprising pressing the elongated bodies toward one another on an end of the apparatus opposite the pressure heads. Also, in one embodiment the force mechanism is a spring engaging the elongated bodies urging the pressure heads together, the spring force urging the pressure heads closed. Also, in one embodiment the substantially planar sacrificial anode is substantially circular.

In one embodiment of the method the first and second elongated bodies are symmetrical about a long axis and the pressure heads and the sacrificial anode are adapted to approximate the shape of a head of a safety razor, each having a greater dimension at a right angle to the long axis and a smaller dimension in the direction of the long axis. In one embodiment the substantially planar sacrificial anode is made predominantly of zinc. And in one embodiment the substantially planar sacrificial anode is made predominantly of magnesium.

### BRIEF DESCRIPTION OF THE SEVERAL VIEWS OF THE DRAWINGS

FIG. 1 is a perspective view of an apparatus for pairing a galvanic anode with a razor blade mounted in a safety razor apparatus in an embodiment of the invention.

FIG. 2 is a perspective view of a safety razor in the prior art.

FIG. 3 is a perspective view of the apparatus of FIG. 1 clamped to a safety razor in an embodiment of the invention.

FIG. 4 is a perspective view of an alternative apparatus in an embodiment of the invention.

### DETAILED DESCRIPTION OF THE INVENTION

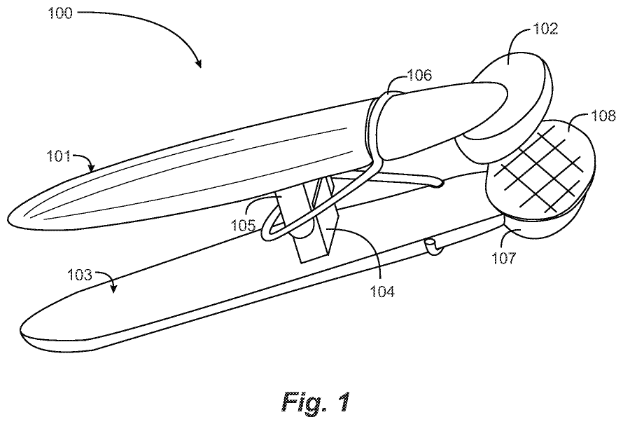

FIG. 1 is a perspective view of an apparatus 100 for pairing a galvanic anode with a razor blade mounted in a safety razor apparatus in an embodiment of the invention. Apparatus 100 in this example is a spring-loaded clamp comprising a first elongated body 101 having a pressure head 102 on one end, and a second elongated body 103 having a pressure head 107 on one end. Body 101 has a centrally located post 105 pivoted to a centrally located post 104 of body 103. A spring element 106 engages body 101 in a groove over the top of body 101, passes around posts 104/105, and engages body 103 in a groove under body 103, such that pressure heads 102 and 107 are urged together. A user may grasp apparatus 100 over the bodies at the end opposite the pressure heads and may squeeze the bodies together, causing the pressure heads to move apart.

A skilled person will understand that clamp apparatus similar to apparatus 100 are conventional and commercially available, from spring-loaded wooden clothes pins to spring-loaded plastic and metal clamps of many makes and models. Any one of a broad variety of such spring-loaded apparatus may be incorporated in an embodiment of the invention.

In one embodiment of the invention a metal plate 107 as seen in FIG. 1 is joined to one of pressure heads 102 or 107, in this example to pressure head 107 to act as a sacrificial anode in an embodiment of the invention. Sacrificial anode 108 may be circular and relatively thin in thickness as shown in FIG. 1. In alternative embodiments anode 107 may take other shapes and thickness may vary. Anode 108 may be joined to pressure head 107 as shown by adhesive or by a conventional fastener or fasteners. It may alternatively be joined to pressure head 102. In one embodiment the material of anode 108 may be zinc, an element with atomic number 30, and in an alternative embodiment the material may be magnesium, an element with atomic number 12. Either metal may be used in embodiments of the invention depending on such as availability and cost. An amalgam of the metals may be used as well.

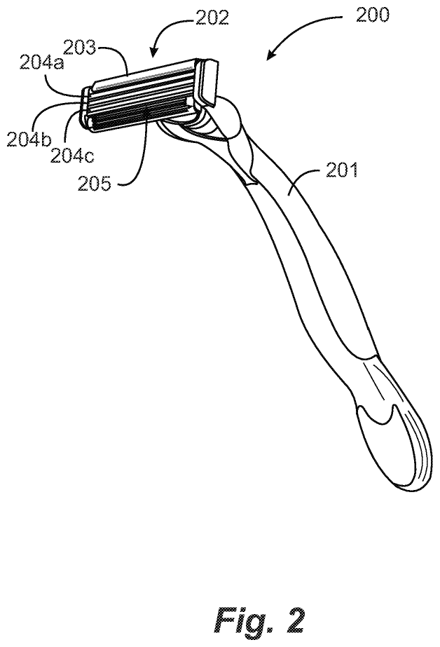

FIG. 2 is a perspective elevation view of a safety razor 200 having a handle 201 and a shaving head 202 attached pivotally to the handle. There are three blades 204a, 204b and 204c in this example. A flexible and resilient cushioning pad 203 is positioned above the blades, and a plastic element 205 below the blades. In many commercially available safety razors like the example illustrated here the blades are provided in an assembly of multiple metal blade strips with a cushioning element, the assembly adapted to clip into the safety razor.

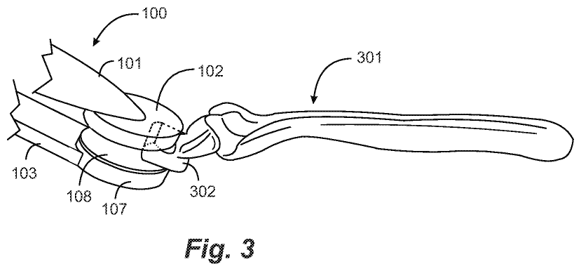

FIG. 3 is a perspective view of apparatus 100 of FIG. 1 clamped to a safety razor 301 in an embodiment of the invention. Safety razor 301 in this example has a shaving head 302 which has blades for shaving. Razor 301 is analogous to razor 200 of FIG. 2. Pressure head 102 of apparatus 100 contacts an upper region of head 302 and sacrificial anode 108 attached to pressure head 107 contacts the underside of shaving head 302, and hence the blades installed in the shaving head, as the blades typically protrude from the head, or they would not contact the user's skin. The apparatus 100 is clamped to the head of the razor between uses of the razor to corrode preferentially to the blades.

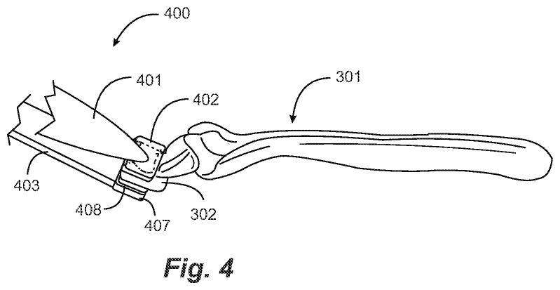

FIG. 4 is a perspective view of an alternative apparatus 400 comprising a first elongated body 401 with a pressure head 402 at an end. A second elongated body 403 has a pressure head 407 at one end. Bodies 401 and 403 are engaged with a pivot and a spring as is illustrated in FIG. 1 for apparatus 100, such that pressure heads 402 and 407 may be opened and allowed to close as described above with reference to FIG. 1. Pressure head 407 has a sacrificial anode 408 attached. Apparatus 400 may be opened and engaged to shaving head 302 of safety razor 301 just as described above for apparatus 100.

A salient difference between apparatus 100 and apparatus 400 is the shape of the pressure heads 402 and 407. In apparatus 400 the pressure heads have a shape elongated in a direction of the width of shaving head 302 and shortened in the directing of the handle of the safety razor. In this example the shape of the pressure heads is rectangular with rounded corners. An important purpose is to better approximate the shape of the shaving head, which allows use of considerably less metal for the sacrificial anode. In other alternative embodiments other shapes may be incorporated, such as oval shapes. Any shape may be incorporated that may better suit a safety razor to which the apparatus may be applied.

The skilled artisan will understand that the embodiments illustrated and described above are exemplary only and are not limiting to the scope of the invention. There may be a variety of alterations made to the embodiments without departing from the scope of the invention. The scope is limited only by the claims that follow.

1. An apparatus, comprising;
a first pressure head on a first body;
a second pressure head on a second body;
a mechanism between the first and the second bodies, adapting the first and the second pressure heads to close together and to open;
a substantially planar sacrificial anode joined to the first pressure head on a surface facing the second pressure head;
a force mechanism between the first and the second bodies providing force urging the pressure heads together; and
a manually operable mechanism adapted to counteract the force mechanism to separate the pressure heads.

2. The apparatus of claim 1 wherein the first and the second body are elongated bodies joined by a pivot mechanism at a substantially central point such that urging the elongated bodies toward one another on an end of the apparatus opposite the pressure heads opens the pressure heads, and releasing the elongated bodies on the same end closes the pressure heads.

3. The apparatus of claim 2 wherein the force mechanism is a spring engaging the elongated bodies urging the pressure heads together.

4. The apparatus of claim 1 wherein the pressure heads and the substantially planar sacrificial anode are substantially circular.

5. The apparatus of claim 2 wherein the first and second elongated bodies are symmetrical about a long axis and the pressure heads and the sacrificial anode are adapted to approximate the shape of a head of a safety razor, each having a greater dimension at a right angle to the long axis and a smaller dimension in the direction of the long axis.

6. The apparatus of claim 1 wherein the substantially planar sacrificial anode is made predominantly of zinc.

7. The apparatus of claim 1 wherein the substantially planar sacrificial anode is made predominantly of magnesium.

8. A method, comprising:
joining a sacrificial anode to a first pressure head on an end of a first body on a surface of the first body facing a second pressure head on an end of a second body;
adapting a first mechanism between the first and the second bodies enabling the bodies to separate and to close together, separating and closing the first and the second pressure heads;
adapting a second mechanism between the first and the second bodies providing force urging the pressure heads together;
providing a manually operable mechanism adapted to counteract the force mechanism to separate the pressure heads;
manipulating the manually operable mechanism, separating the pressure heads;
positioning the second pressure head above a shaving head of a safety razor with the first pressure head having the sacrificial anode below the shaving head, on a side of the shaving head having blades; and
manipulating the manually operable mechanism allowing the pressure heads to close, the sacrificial anode urged against the blades in the shaving head of the safety razor.

9. The method of claim 8 further comprising leaving the pressure heads clamped to the shaving head, protecting the razor blades from corrosion, until the razor is again required for use.

10. The method of claim 8 wherein the manually operated mechanism comprises the first and the second body as elongated bodies joined by a pivot mechanism at a substantially central point, manipulating the mechanism comprising pressing the elongated bodies toward one another on an end of the apparatus opposite the pressure heads.

11. The method of claim 8 wherein the force mechanism is a spring engaging the elongated bodies urging the pressure heads together, the spring force urging the pressure heads closed.

12. The method of claim 8 wherein the substantially planar sacrificial anode is substantially circular.

13. The method of claim 10 wherein the first and second elongated bodies are symmetrical about a long axis and the pressure heads and the sacrificial anode are adapted to approximate the shape of a head of a safety razor, each having a greater dimension at a right angle to the long axis and a smaller dimension in the direction of the long axis.

14. The method of claim 8 wherein the substantially planar sacrificial anode is made predominantly of zinc.

15. The method of claim 7 wherein the substantially planar sacrificial anode is made predominantly of magnesium.
